(19) United States
(12) Patent Application Publication
(10) Pub. No.: US 2010/0319859 A1
(43) Pub. Date: Dec. 23, 2010

(54) LADDER CORD LATTICE FOR WINDOW BLINDS

(75) Inventor: Tsung-Hsiung TSAI, Jhushan Township (TW)

Correspondence Address: EGBERT LAW OFFICES, 412 MAIN STREET, 7TH FLOOR, HOUSTON, TX, 77002, US

(73) Assignee: Taihao Knitting Belt Co., Ltd., Dongguan City (CN)

(21) Appl. No.: 12/490,135

(22) Filed: Jun. 23, 2009

(51) Int. Cl. E06B 9/382

(52) U.S. Cl. 160/178.3

(57) ABSTRACT

The present invention provides a ladder cord lattice for window blinds. The ladder cord lattice includes a front strip, a rear strip and multiple slat sustaining portion arranged at intervals between the front and rear strips. There is a connecting and positioning portion, being integrally formed on the top of front and rear strip and lacking the slat sustaining portion. There are tailoring point identification bulges, and snapper locating point identification bulges. There is a clear identification point for tailoring and feeding of ladder cord lattice and for fixing of the snapper via the tailoring point identification bulges and snapper locating point identification bulges, thus reducing the error of feeding and assembly, and improving the operating efficiency, accuracy and quality for higher applicability and industrial efficiency.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a ladder cord lattice for window blinds, and more particularly to an innovative ladder cord lattice with a connecting and positioning portion fitted with tailoring point identification bulges and snapper locating point identification bulges.

2. Description of Related Art Including Information Disclosed Under 37 CFR 1.97 and 37 CFR 1.98.

A ladder cord lattice (or a ratline) is a component of blinds that enables transversal positioning and simultaneous swinging of the slats of the blinds.

The ladder cord lattice is of either a sheet or a rope pattern, and generally composed of front and rear strips as well as a slat sustaining portion connected between front and rear strips. First, a rolled substrate is fabricated, and then tailored into unit strips of preset length for processing into the blinds, depending on the intended number of slats.

When it is intended to cut the ladder cord lattice into unit strips, some influential factors regarding accuracy and quality of assembled slat shall be considered. At the top of the stripped ladder cord lattice, a connecting and positioning portion must be reserved. The connecting and positioning portion is used for threading into a rotary braking seat preset in the blinds lever. Then, the connecting and positioning portion is positioned securely via a snapper. Any error of the connecting point of the snapper will lead to poor assembly accuracy of the slats due to inconsistent positioning points.

The tailoring of the ladder cord lattice, the threading of the rotary braking seat of the blinds lever and the linking of the snapper have to be realized manually as shown in FIG. 1(a). First, the assembly personnel must set the number of ladder cord lattices (20, 30, - - - ) from the rolled ladder cord lattice substrate 10 and then tailor them. Next as shown in FIG. 1(b), there is the stripped ladder cord lattice 11, and the assembly personnel must remove the slat sustaining portions 12 of preset quantity at the top so as to form the connecting and positioning portion 13. Next, as shown in FIG. 1(c), the assembly personnel may press a snapper 16 onto the preset recessed spacing (W1) at the end of the connecting and positioning portion 13. Next, as shown in FIG. 1(d), the connecting and positioning portion 13 at top of the ladder cord lattice 11 is threaded into a rotary braking seat 15 preset in the blinds lever 14, and then positioned securely via the snapper 16. So the ladder cord lattice 11 and the rotary braking seat 15 are assembled so that the ladder cord lattice 11 is vertically positioned without disengagement.

However, there are shortcomings observed during actual applications.

As the tailoring of the ladder cord lattice 11 proceeds, the threading of the rotary braking seat 15 of the blinds lever 14 and linking of the snapper 16 are realized manually. Mistakes may occur due to possible erroneous calculation of the number of ladder cord lattices or erroneous measurement of the preset recessed spacing at the end of the connecting and positioning portion 13. Moreover, since the ladder cord lattice 11 lacks of structural design for a reference purpose, quality inspection personnel may find it difficult to efficiently and quickly inspect the products in the case of assembly error. Furthermore, inefficiency of cutting exists obviously since at least three slat sustaining portions 12 (i.e. 6 cutting procedures) must be cut off from every unit ladder cord lattice 11.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

With the tailoring point identification bulge, it is possible to provide a clear identification point for tailoring and feeding of ladder cord lattice, thus reducing the probability of error for higher operating efficiency, accuracy and performance. In a subsequent quality inspection, the inspectors may verify easily the tailoring accuracy with reference to the tailoring point identification bulge, helping to realize an improved applicability and industrial efficiency.

With the snapper locating point identification bulge, it is possible to provide a clear identification point for the snapper, whereby the assembly personnel could easily and quickly pinpoint the location of the snapper, thus reducing the error of assembly, improve the operating efficiency, accuracy and performance. In a subsequent quality inspection, the inspectors may verify easily the mating point of the snapper with reference to the snapper locating point identification bulge, helping to realize an improved applicability and industrial efficiency.

Based on the connecting and positioning portion having a straight pattern without slat sustaining portion, the problem of cutting off several slat sustaining portions is eliminated, thus shortening significantly the manufacturing process, improving the efficiency and reducing costs with higher economic efficiency.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a schematic view of the operating steps of the prior art.

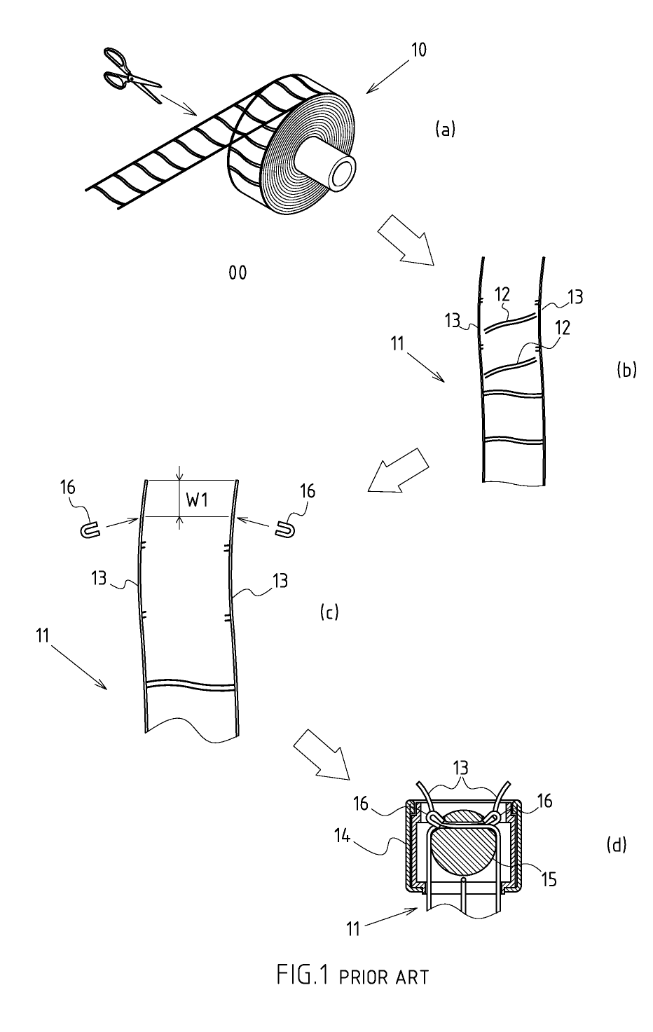

FIG. 2 shows an elevation view of preferred embodiment of the ladder cord lattice of the present invention.

FIG. 3 shows an assembled perspective view of the blinds of the present invention.

FIG. 4 shows a partial perspective view of the structure of the present invention.

FIG. 5 shows a schematic view of the operating steps of the present invention.

FIG. 6 shows a schematic and elevation view of another preferred embodiment of the present invention.

FIG. 7 shows a perspective view of a preferred embodiment of rolled ladder cord lattice of the present invention.

### DETAILED DESCRIPTION OF THE INVENTION

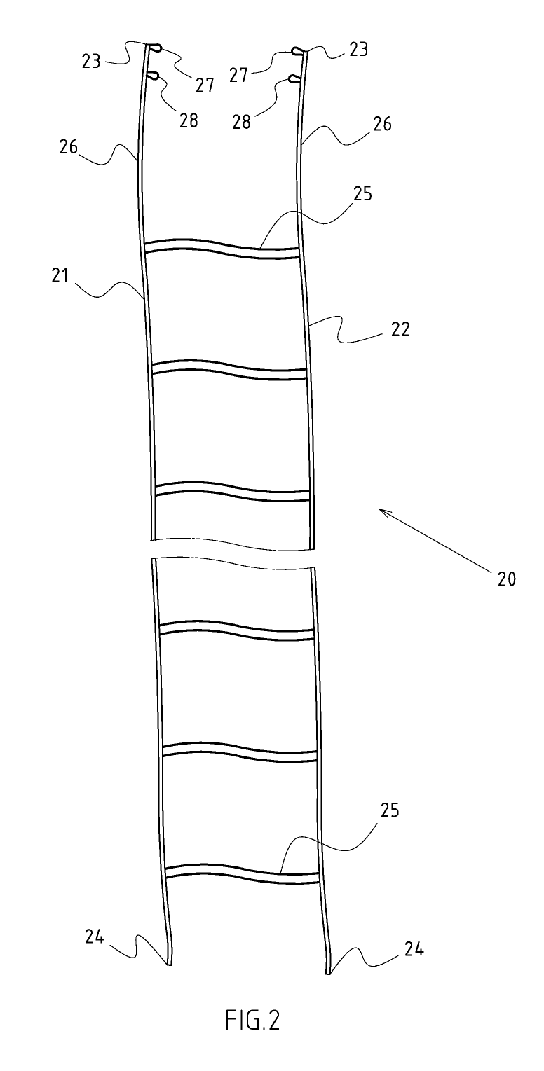

FIG. 2 depicts a preferred embodiment of a ladder cord lattice and blinds of the present invention. The embodiments are provided for only explanatory objectives with respect to the patent claims.

The ladder cord lattice 20 is used for assembly onto the blinds in a predefined strip pattern.

The ladder cord lattice 20 comprises a front strip 21 and a rear strip 22, both of which are arranged at intervals. The front and rear strips 21,22 are extended to define a top 23 and a bottom 24.

Multiple slat sustaining portions 25 are linked between the front and rear strips 21, 22 at intervals.

A connecting and positioning portion 26 is integrally formed on the top 23 of the front and rear strips 21, 22. The connecting and positioning portion 26 of a straight pattern eliminates the problem of cutting off several slat sustaining portions 25.

Two tailoring point identification bulges 27 are integrally formed on the first set position of the connecting and positioning portion 26 at top 23 of the front and rear strips 21, 22.

Two snapper locating point identification bulges 28 are integrally formed on the second set position of the connecting and positioning portion 26 at top 23 of the front and rear strips 21, 22. There is a spacing between the first and second set positions.

The front and rear strips 21, 22 as well as the slat sustaining portion 25 are of rope or sheet patterns.

The tailoring point identification bulges 27 and snapper locating point identification bulges 28 can be assembled into loop patterns woven directly by the weaving threads of the front and rear strips 21, 22. In addition, the tailoring point identification bulges 27 and snapper locating point identification bulges 28 can also be protruding stubs.

The tailoring point identification bulges 27 and snapper locating point identification bulges 28 can be formed at either side of the front and rear strips 21, 22. Referring to FIG. 2, the tailoring point identification bulges 27 and snapper locating point identification bulges 28 of the preferred embodiment are arranged oppositely at inner side of the front and rear strips 21, 22.

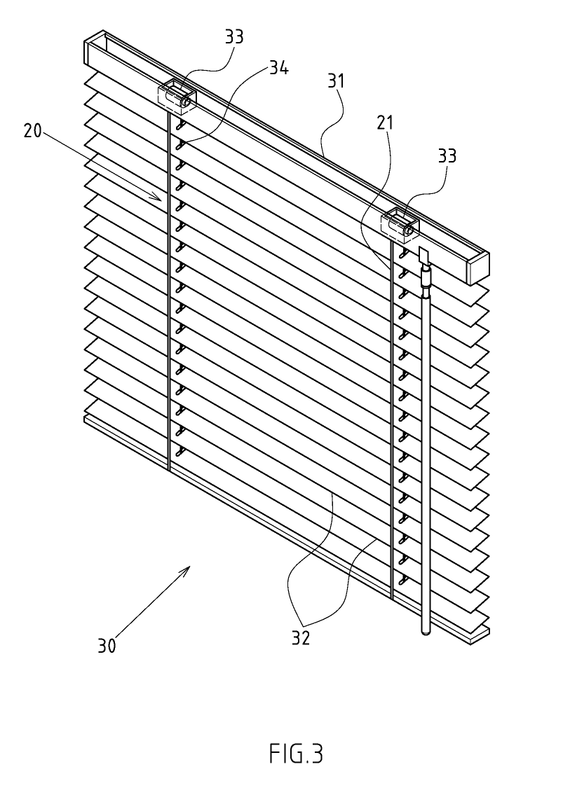

Referring to FIG. 3, the ladder cord lattice 20 is assembled onto the blinds 30, wherein the blinds 30 comprises a lever 31, multiple slats 32, at least two rotary braking seats 33 and a pull rope 34. The ladder cord lattice 20 is threaded into the rotary braking seat 33 via the connecting and positioning portion 26 at the top 23, and then fixed on the snapper locating point identification bulge 28 via a snapper 40, such that the connecting and positioning portion 26 along with the ladder cord lattice 20 can be positioned securely.

Based on above-specified structure, the present invention is operated as follows:

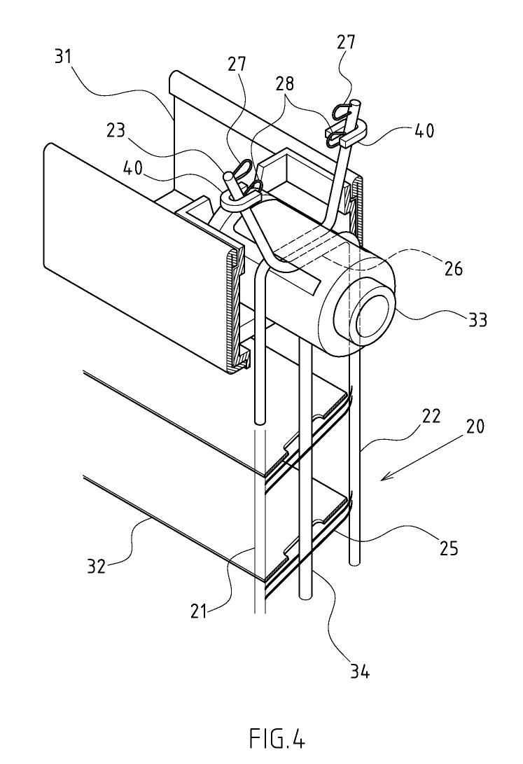

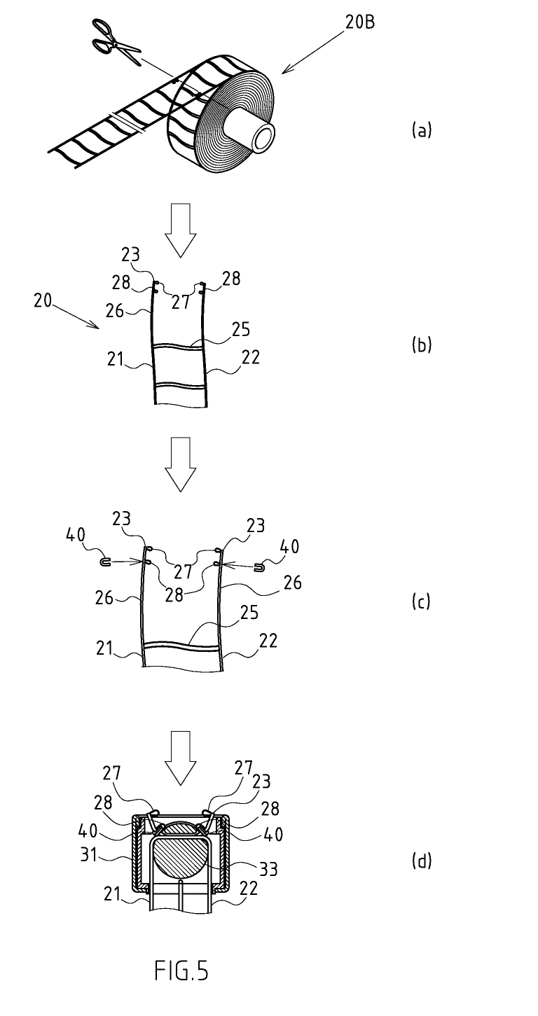

Referring to FIG. 5(a), first, the assembly personnel must pull the substrate of rolled ladder cord lattice 20B to the tailoring point identification bulge 27. Referring also to FIG. 5(b), it can be tailored into strips of ladder cord lattice. Referring also to FIG. 5(c), the snapper 40 is fixed on the snapper locating point identification bulge 28 set for the connecting and positioning portion 26. Referring also to FIG. 5(d), the connecting and positioning portion 26 at top 23 of the ladder cord lattice 20 is threaded into the rotary braking seat 33 of the blinds lever 30, and then positioned securely along with the ladder cord lattice 20 via the snapper 40. So, the ladder cord lattice 20 and the rotary braking seat 33 are assembled to enable vertical and secure application of the ladder cord lattice 20 (in conjunction with FIG. 4).

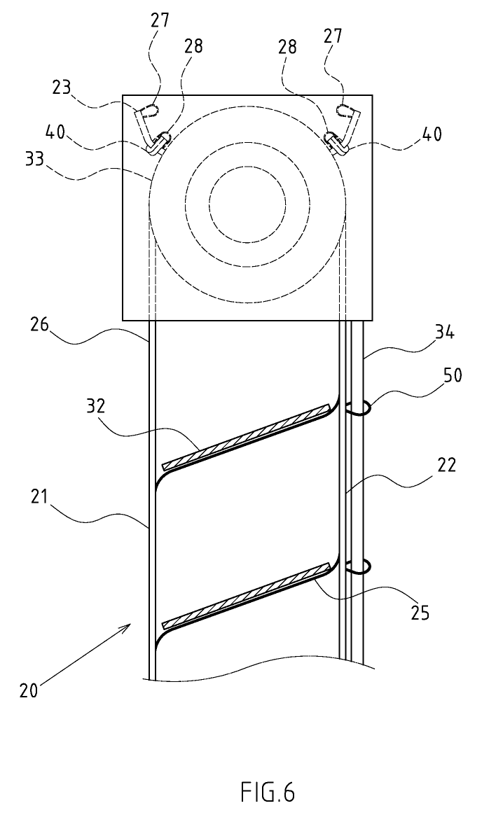

Referring to FIG. 6, a pull rope's threading ring 50 is formed oppositely on the exterior of the front strip 21 or rear strip 22, such that the pull rope 34 of the blinds 30 can be threaded securely.

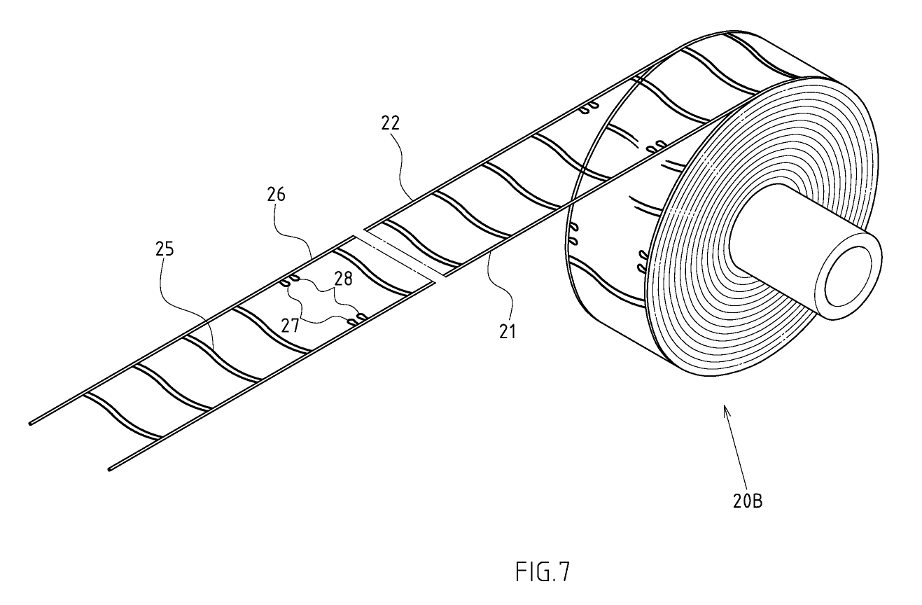

Referring to FIG. 7, the ladder cord lattice 20B also comprises an integrally rolled substrate.

1. A ladder cord lattice having a predefined strip pattern, said ladder cord lattice comprising:
a front strip;
a rear strip, the front and rear strips being arranged at intervals and extended to define a top and a bottom;
a plurality of slat sustaining portions, linked between the front and rear strips at intervals;
a connecting and positioning portion, being integrally formed on the top of the front and rear strips and having a straight pattern so as to eliminate cutting off slat sustaining portions; and
two snapper locating point identification bulges, integrally formed on a set position of the connecting and positioning portion at tops of the front and rear strips.

2. The ladder cord lattice defined in claim 1, wherein the front and rear strips and the slat sustaining portion are of rope or sheet patterns.

3. The ladder cord lattice defined in claim 1, wherein the snapper locating point identification bulges are assembled into loop patterns woven directly by the weaving threads of the front and rear strips.

4. The ladder cord lattice defined in claim 1, wherein the snapper locating point identification bulges are formed at either side of the front and rear strips.

5. The ladder cord lattice defined in claim 1, further comprising:
a pull rope with a threading ring is formed oppositely on the exterior of the front or rear strip.

6. The ladder cord lattice defined in claim 1, wherein the two tailoring point identification bulges are formed integrally on the other set position of the connecting and positioning portion of front and rear strips.

7. The ladder cord lattice defined in claim 6, wherein the tailoring point identification bulges are assembled into loop patterns woven directly by the weaving threads of the front and rear strips.

8. A ladder cord lattice, being formed integrally as a rollable pattern, the ladder cord lattice comprising:
a front strip and a rear strip, the strips being arranged at intervals and being extended into an elongated shape;
a plurality of slat sustaining portions, linked between the front and rear strips at intervals;
a connecting and positioning portion, being integrally formed on the set position of the front and rear strips; and
two snapper locating point identification bulges, integrally formed on a set position of the connecting and positioning portion.

9. The ladder cord lattice defined in claim 8, wherein the front and rear strips and the slat sustaining portion are of rope or sheet patterns.

10. The ladder cord lattice defined in claim 8, wherein the snapper locating point identification bulges are assembled into loop patterns woven directly by the weaving threads of the front and rear strips.

11. The ladder cord lattice defined in claim 8, wherein the snapper locating point identification bulges are formed at either side of the front and rear strips.

12. The ladder cord lattice defined in claim 8, further comprising:
a pull rope with a threading ring formed oppositely on an exterior of the front or rear strip.

13. The ladder cord lattice defined in claim 8, wherein two tailoring point identification bulges are formed integrally on the other set position of the connecting and positioning portion of front and rear strips.

14. The ladder cord lattice defined in claim 13, wherein the tailoring point identification bulges are assembled into loop patterns woven directly by the weaving threads of the front and rear strips.

15. A blinds assembly, comprising:
a ladder cord lattice according to claim 1;
a lever, a slat and rotary braking seat; and
a pull rope, said ladder cord lattice being threaded into the rotary braking seat through the connecting and positioning portion at the top, and then fixed onto the snapper locating point identification bulge via a snapper, such that the connecting and positioning portion can be positioned securely.
